(19) United States
(12) Patent Application Publication
(10) Pub. No.: US 2017/0124029 A1
(43) Pub. Date: May 4, 2017

(54) SYSTEM AND METHOD OF PRODUCING DYNAMICALLY CUSTOMIZED IMAGES

(71) Applicant: Nvidia Corporation, Santa Clara, CA (US)

(72) Inventor: MICHAEL HOUSTON, Saratoga, CA (US)

(21) Appl. No.: 14/929,208

(22) Filed: Oct. 30, 2015

(51) Int. Cl. G06F 17/21; G06T 3/40

(52) U.S. Cl. CPC G06F 17/212; G06T 3/40

(57) ABSTRACT

Embodiments of the claimed subject matter provide systems and methods for determining a rendering size of an image and resizing the image based on the rendering size of the image. The method can include accessing layout information associated with a webpage to be rendered. The webpage comprises a reference to the image. The method further includes determining a rendering size of the image based on the layout information and accessing the reference to the image. The method further includes modifying the reference to the image based on the rendering size of the image.

### RELATED U.S. APPLICATIONS

This application is related to the non-provisional patent application Ser. No. 14/149,327, Attorney Docket Number 13-SC-1338-US02, entitled “SYSTEM AND METHOD FOR SHARING SPECIAL-PURPOSE PROCESSING RESOURCES,” with filing date Jan. 7, 2014, which claims priority to provisional patent application Ser. No. 61/878,960, Attorney Docket Number 13-SC-1338US01, entitled “GPU-ACCELERATED IMAGE PROCESSING WEB SERVICE,” with filing date Sep. 17, 2013, each of which are hereby incorporated by reference in their entirety.

### FIELD OF THE INVENTION

Embodiments of the present invention are generally related to webpages and associated images.

### BACKGROUND

As technology has advanced, computers have become increasingly smaller and more portable while incorporating one or more wireless communication systems. Communications through these wireless communication systems often are at reduced speed as compared to wired network connections, while allowing a user to access the Internet practically anywhere there is wireless service. The bulk of data transmitted during Internet access constitute images and video of webpages.

Conventional solutions to deal with the relatively slower wireless Internet connections and the large amount of bandwidth needed to transmit images have focused on statically producing copies of images at preselected sizes based on the original images. Based on a user's device, web browser, or code on the webpage, one of the preselected sizes is selected to be downloaded and used to display the webpage. This creates a problem when the image selected is of too low a resolution and is scaled up by the web browser resulting in a distorted image. As a result, often times the preselected size is larger than needed to avoid having the web browser scale up the selected image. This results in sending more data than needed for an image and having the web browser reduce the size. As a result, larger sized images than will be displayed are transmitted and the webpage loads at a slower rate.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A need has arisen for a solution that provides images that are sized appropriately for devices (e.g., mobile devices) thereby reducing the bandwidth consumed in downloading and displaying a webpage.

Accordingly, embodiments of the present invention are configured to determine a size at which each image of a webpage will be rendered and facilitating resizing of each image of the webpage. Each resized image matches the size that the image will be rendered at (on a device) thereby allowing transmission of an image with a size customized to the size the image will be displayed. Embodiments of the present invention thereby reduce bandwidth utilization for image transmission. This reduction in bandwidth utilization results in increased webpage rendering speed. Embodiments of the present invention further reduce the processing power needed to download the image and processing power used to resize images on a mobile device.

One embodiment of the present invention is directed to a method for rendering a webpage. The method includes accessing the webpage. The webpage comprises an image. The method further includes accessing code for determining a rendering size of the image and determining the rendering size of the image using the code. In some embodiments, the code queries a Document Object Model (DOM) of the webpage. In some embodiments, the code is configured to determine the rendering size of the image prior to the rendering of the webpage. In some embodiments, the code is configured to modify a reference to the image of the webpage. The reference to the image of the webpage can be modified to include the rendering size of the image. The method further includes requesting the image, where the request comprises the rendering size of the image and then receiving a resized image. The resized image has a size equal to the rendering size of the image. In some embodiments, the resized image is generated by a Graphics Processing Unit (GPU). In some embodiments, the resized image is generated using just-in-time transcoding. The method further includes rendering the webpage. The rendering of the webpage comprises displaying the resized image.

Another embodiment of the present invention is directed to a method of processing a request. The method includes receiving a request for an image. The request comprises a rendering size of the image. The method further includes accessing the image based on the request for the image and resizing the image based on the rendering size of the image to produce a resized image. The request for the image can include a Uniform Resource Location (URL) comprising the rendering size of the image. The accessing of the image can include accessing the image from local storage. The accessing of the image can include accessing the image from a remote source. In some embodiments the resizing of the image based on the rendering size of the image is performed with a Graphics Processing Unit (GPU). In some embodiments, the resized image is produced with just-in-time transcoding. The resizing of the image can be performed based on a quality factor. The method further includes sending the resized image in response to the request for the image. The method can further include storing the resized image.

The method can further include receiving a request for a webpage associated with the image, accessing the webpage, and adding code to the webpage to produce a modified webpage. The code is configured for determining a rendering size of the image. The method can further include sending the modified webpage in response to the request for the webpage.

Another embodiment of the present invention is directed to a computer-readable storage medium having stored thereon, computer executable instructions that, if executed by a computer system cause the computer system to perform a method for facilitating resizing of an image. The method can include accessing layout information associated with a webpage to be rendered. The webpage comprises a reference to the image. In some embodiments, the accessing of the layout information comprises querying a Document Object Model (DOM). The method further includes determining a rendering size of the image based on the layout information and accessing the reference to the image. The rendering size of the image can be based on the resolution of a display device. The method further includes modifying the reference to the image based on the rendering size of the image. The modifying of the reference to the image can include modifying the reference to include the rendering size of the image.

### BRIEF DESCRIPTION OF THE DRAWINGS

The accompanying drawings are incorporated in and form a part of this specification. The drawings illustrate embodiments. Together with the description, the drawings serve to explain the principles of the embodiments:

FIG. 1 shows exemplary on-screen renderings of a webpage at different resolutions, in accordance with various embodiments of the present invention.

FIG. 2 shows exemplary communications involved in rendering of a webpage, in accordance with embodiments of the present invention.

FIG. 3 shows exemplary communications with a proxy involved, in accordance with embodiments of the present invention.

FIG. 4 shows an exemplary computer implemented process for rendering a webpage, in accordance with various embodiments.

FIG. 5 shows an exemplary computer implemented process for processing a request, in accordance with various embodiments.

FIG. 6 shows an exemplary computer implemented process for facilitating resizing of an image, in accordance with various embodiments.

FIG. 7 shows a block diagram of an exemplary computer system platform and associated modules in accordance with various embodiments.

FIG. 8 shows a computer system in accordance with various embodiments.

### DETAILED DESCRIPTION

Reference will now be made in detail to the preferred embodiments of the claimed subject matter, a system and method of determining a size at which each image of a webpage will be rendered and facilitating resizing of each image of the webpage, examples of which are illustrated in the accompanying drawings. While the claimed subject matter will be described in conjunction with the preferred embodiments, it will be understood that they are not intended to limit these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to obscure unnecessarily aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “generating,” “protecting,” “receiving,” “sending,” “determining,” “selecting,” “initiating,” “mapping,” “translating,” “accessing,” “writing,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

### System and Method of Producing Dynamically Customized Images

Embodiments of the present invention are configured to determine a size at which each image of a webpage will be rendered and facilitating resizing of each image of the webpage. Each resized image matches the size that the image will be rendered at (on a device) thereby allowing transmission of an image with a size customized to the size the image will be displayed. Embodiments of the present invention thereby reduce bandwidth utilization for image transmission. This reduction in bandwidth utilization results in increased webpage rendering speed. Embodiments of the present invention further reduce the processing power needed to download image and processing power used to resize images on a mobile device.

Embodiments of the present invention are further configured to increase efficiency for slower data connections. For example, if a user is using a 3G wireless network or drops from a 4G network to a 3G network, the reduced size of the images loads faster due to having a smaller size in bytes. Embodiments of the present invention further reduce power consumption because there is less power used for receiving data due to the reduced-size images.

Embodiments of the present invention may use the Image Compute Engine (ICE) available from NVidia Corporation of Santa Clara, Calif. Embodiments may use any system configured for processing images (e.g., Joint Photographic Experts Group (JPEG) and WebP images) for dynamic and on demand or just-in-time resizing. In some embodiments, the use of a GPU allows low latency resizing of images. The dynamically generated images can be used in place of the presized images (e.g., with 4-8 different size) and save bandwidth by scaling images according to the size the images will be rendered at by the web browser.

Embodiments of the present invention can include code that is executed by the browser that determines the size that an image will be rendered at or displayed. The size of the image can then be sent to a server which resizes the image and sends the image for display by the browser. As a result, bandwidth utilization for transmitting the image is reduced and the number of bits sent for transmitting the image is minimized. The result is better response time for the webpage and less bandwidth used. Further, the bandwidth costs associated with the website and service providers are reduced.

Embodiments are described with respect to digital content including images but this is exemplary only and embodiments may be used with any type of content or data type. Embodiments are described with respect to a GPU but can be used with any type of processor including a Central Processing Unit (CPU), System On a Chip (SoC), integrated CPU/GPU processors, Acorn RISC Machine (ARM) processors, etc.

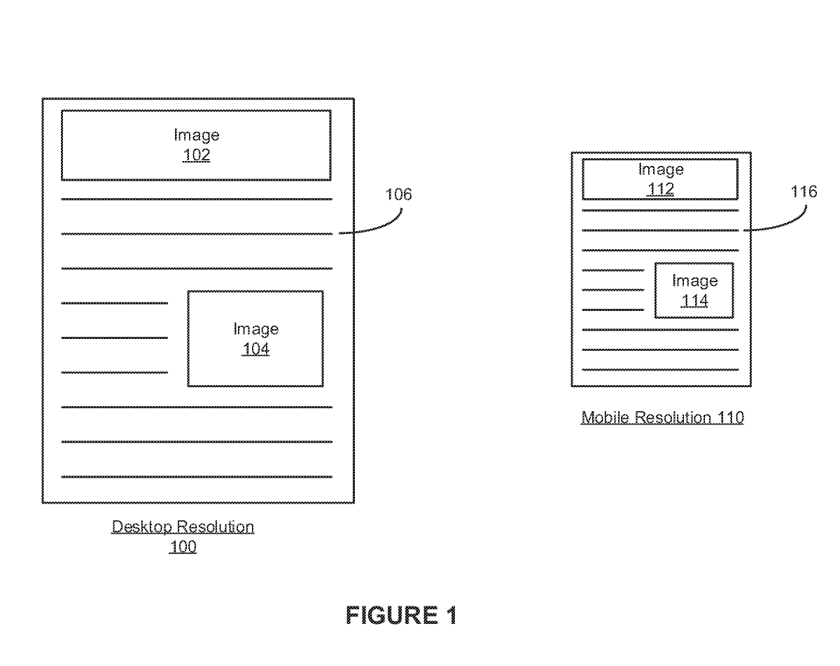

FIG. 1 shows exemplary renderings of a webpage at different resolutions, in accordance with various embodiments of the present invention. FIG. 1 depicts exemplary renderings of a webpage at a desktop resolution 100 and at a mobile resolution 110.

The webpage page shown in FIG. 1 is shown at a desktop resolution (e.g., a 4K resolution) and a mobile resolution 110 (e.g., 1080p). The webpage includes embedded images 102-104 and text 106 at the desktop resolution 100 and includes embedded images 112-114 and text 116 at the mobile resolution 110. The images 102-104 may be displayed at their original sizes while images 112-114 are scaled according to the smaller mobile resolution 110. The text 106 is also scaled smaller as text 116 according to the smaller mobile resolution.

The webpage page of FIG. 1 may be displayed on a variety of devices including a computer monitor, a television (e.g., with a 60 inch 4K screen), a tablet (e.g., with a 9 inch 4K or 1080p screen), a smartphone (e.g., with a 5 inch 720p or 1080p screen), etc. As a result, the webpage may be displayed on displays of various sizes and resolutions. When a browser renders the webpage, each image is displayed at a size associated with the screen size and the resolution of the screen.

Some webpage designers produced statically scaled versions of the embedded images of the webpage at particular sizes. For example, for a photo sharing website, a user may upload a 12 megapixel image which is then scaled to produce a 1920×1080 copy, a 720p copy, a 640×480 copy, and a 320×240 copy. These preselected sizes may be referred to as “breakpoints.” The preselected images may be generated with relatively slow CPU transcoding. Embedded code in the webpage may select which version or size of an image should be downloaded for rendering of the webpage. For example, the version of the image to download may be based on the user agent string of the browser. The web browser may then scale the image based on the screen size and resolution. For example, the 320×240 copy may need to be scaled up for display on a mobile device and looks pixelated as a result. The 640×480 version may be used but have to be reduced in size thereby consuming more bandwidth than needed.

Embodiments of the present invention are configured to access and/or determine the final render size of an image to allow resizing of the image before downloading of the image. In some embodiments, code embedded in the webpage is configured to access and/or query browser rendering information (e.g., including object and size information from the Document Object Model (DOM)) to determine the final render size of each image. Based on the final render sizes the code of the webpage may be modified so that dynamically sized images are downloaded. For example, the webpage includes code for the image of <IMG SRC=“http://domain.com/.../image320×240”> and the render size of the image is determined to be 127×127, the code of webpage may be changed or modified to <IMG SRC=“http://domain2.com/.../image320×240?width=127,height=127”>. In response to the query of the URL of http://domain2.com/.../image320×240?width=127,height=127, the servers resizes the image and sends the image scaled to a size or resolution of 127×127.

Embodiments thereby substantially reduce the number of bits transmitted for the image (e.g., by approximately 5× times for the 320×240 image resized to 127×127). Embodiments of the present invention thereby combine the code of the webpage with server resize functionality to more efficiently utilize bandwidth while avoiding use of preselected image sizes. Embodiments may further store a particular number of sizes (e.g., 16) to enable caching of the resized images.

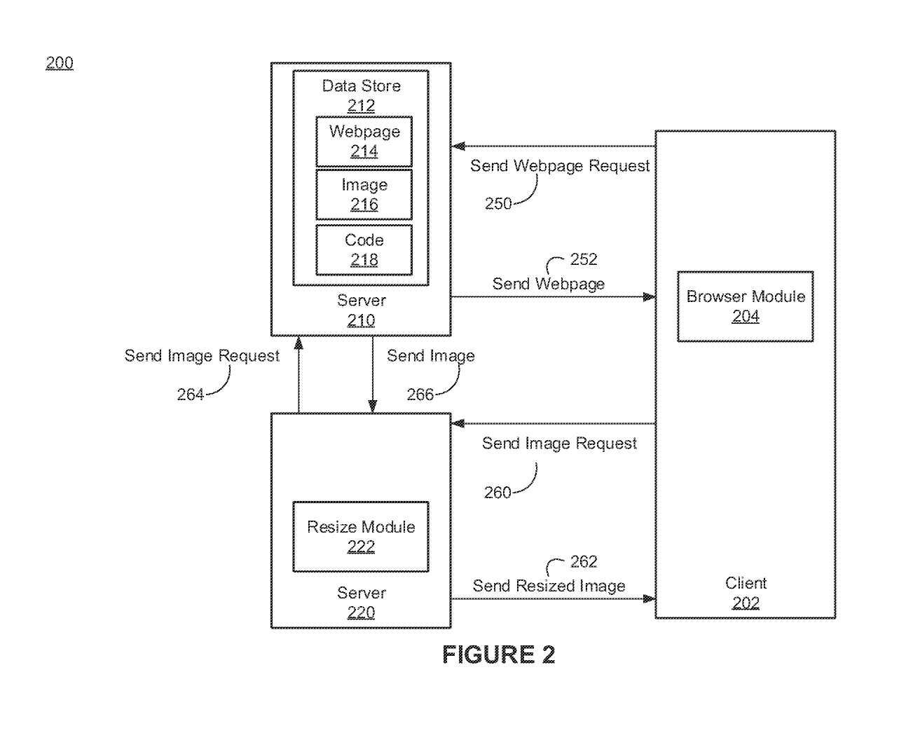

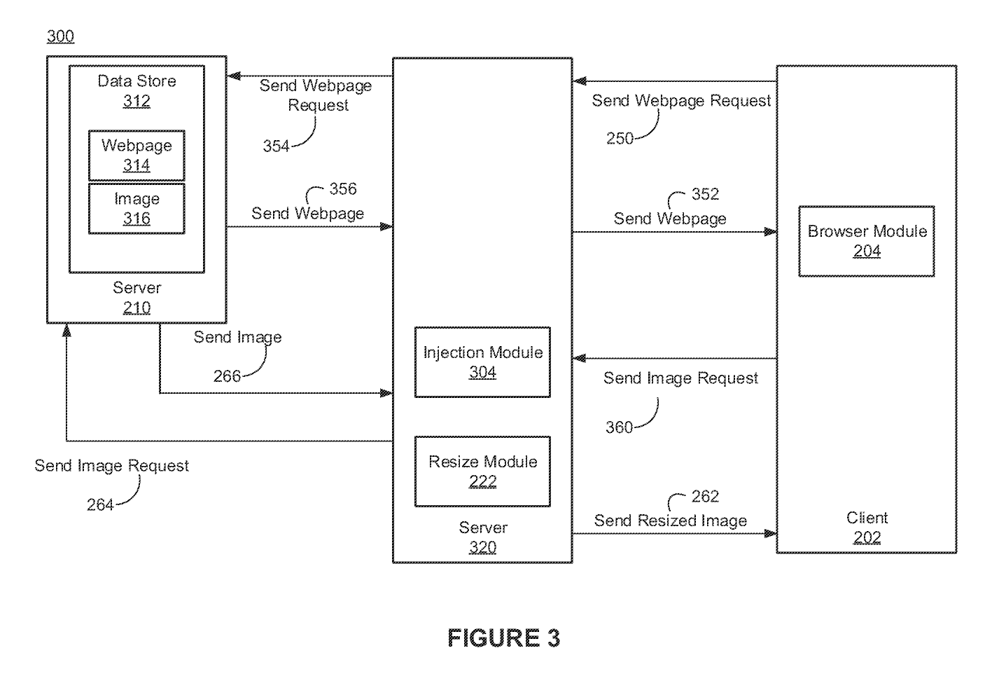

FIGS. 2 and 3 illustrate example components used by various embodiments of the present invention. Although specific components are disclosed in FIGS. 2 and 3, it should be appreciated that such components are exemplary. That is, embodiments are well suited to having various other components or variations of the components recited in 2 and 3. It is appreciated that the components in FIGS. 2 and 3 may operate with other components than those presented, and that not all of the components of FIGS. 2 and 3 are required to practice embodiments of the present invention as described herein.

FIG. 2 shows exemplary communications involved in rendering of a webpage, in accordance with embodiments of the present invention. FIG. 2 depicts an exemplary operating environment 200 and exemplary communications during a request of a webpage, resizing of one or more images, and rendering of the webpage. The exemplary operating environment 200 includes servers 210-220 and a client 202. The servers 210-220 may be communicatively coupled to the client 202 by one or more networks, including a wireless network and the Internet.

The client 202 may be a computing system including, but not limited to, a computer, a mobile phone, a tablet, a game console, etc. The client 202 executes a browser module 204 which allows a user of client 202 to browse the Internet and/or other communications networks. In response to a user entering or selecting a webpage address, the browser module 204 sends a webpage request 250 to a server 210.

The server 210 may be any computing system or device configured for responding to a request for a webpage. The server 210 includes data store 212 which includes a webpage 214, an image 216, and code 218. The image 216 may be referenced by the webpage 214 and is to be displayed as part of rendering the webpage 214. It is appreciated that webpage 214 may reference multiple images. The code 218 may be referenced in the webpage 214 and may be requested as part of the process of rendering the webpage 214. In some embodiments, the code 218 is integrated into webpage 214 and is transmitted as part of the webpage 214.

The server 210 receives a webpage request 250 and in response accesses webpage 214 from a data store 212. The server 210 then sends the webpage 214 as webpage 252 to the client 202. In some embodiments, the webpage 214 has been modified by the server 210 prior to sending the webpage 214 as webpage 252. For example, the webpage 252 may include portions of webpage 214 and dynamically generated content. The webpage 252 is received by the browser module 204. The webpage 252 includes references to the image 216 and the code 218 (e.g., JavaScript). As browser module 204 begins to render webpage 252, the code 218 is run or executed. The code can be fed or query layout parameters of the webpage, including where an image will be when rendered as part of webpage 252. For each image of the webpage 252, the code can determine the size the image will be when the image is rendered. In some embodiments, the code 218 can query the layout of webpage 252 before the rendering is complete and in response to the query get a size in pixels (e.g., height and width) of the image will be when rendered. The code 218 may determine or extract the rendered bounds of an image from a DOM (e.g., based on a DIV element of a webpage including the image). Embodiments may further support the browser module 204 providing the size of the image will be when rendered to the code 218.

The code 218 can then modify the webpage image tags (e.g., <IMG SRC=“URL”>) to request a resized version of the image 216 from the server 220 (e.g., based on the modified URL of the image tag). The image request 260 is then sent to the server 220.

The resize module 222 of the server 220, then locates the image 216. If there is a copy of image 216 local to the server 220 then the server 220 accesses the local copy of the image 216. If there is not a copy of the image 216 local to the server 220, the resize module 222 sends image request 264. The server 210 sends image 216 as image 266 to server 220. After receiving or accessing the image 216, the resize module 222 resizes image and/or performs filtering, encodes the resized image, and send resized image 262 to client 202. The resized image matches the size of the final rendered image. The browser module 204 then renders webpage 214 using the resized image 262.

The server 220 can be any computing system configured for resizing an image based on a resize module 222. The resize module 222 may be implemented in software or hardware. The functionality of the resize module 222 may be executed or performed by a Graphics Processing Unit (GPU). In some embodiments, the functionality of the resize module 222 is performed by the ICE which can generate resized images fast enough to allow just-in-time transcoding of images. In some embodiments, the resized image 262 is not stored and instead is dynamically generated by the resize module 222 for each image request and associated layout parameters and/or size. Thus, instead of 4-8 static sized images, the resize module 222 can support on demand resizing for many different size and associated devices. The resize module 222 further allows a web developer to change the layout of a webpage without having to resize the associated images or deal with the delays of CPU transcoding of images of the webpage. In some embodiments, the resized image may then be cached.

In some embodiments, the resize module 222 is further configured to determine a quality level to be used with the resizing. For example, the JPEG image format supports a quality favor which determines the amount of compression and thus the size of the image. In one embodiment, the default quality factor is set to 85 out of 100 for JPEG images. Embodiments of the present invention can support various quality search metrics that trade off visual acuity for the actual bit rate (e.g., size in bytes) of the resulting image. The resize module 222 may thus determine an optimal coding or quality factor for transcoding the resized image to minimize the file size of the resized image with a desired level of visual acuity. It is appreciated that the image quality of the image output by the resize module 222 may be of substantially higher quality than the quality of images resized by the browser module 204. For example, the quality optimization may be used to substantially reduce the amount of data sent when a navigation application is used with satellite imagery being displayed and the satellite images are frequently downloaded as the user moves.

The resize module 222 may further support filtering of various types including linear interpolation, nearest neighbor, Lanczos filtering, unsharp filtering, denoise filtering, color filters (e.g., the Kelvin, 1977, Walden, Hudson, Inkwell, Sutro, Sierra, Hefe, Toaster, Nashville, Brannan, Willow, Lo-Fi, X Pro II, Valencia, Rise, Amaro, and Mayfair filters). The filtering can be used to remove blurred edges. For example, if the resized image has hard edges like stairs, there may be blurring between the steps. The resize module 222 can apply denoise filtering and color filters dynamically to enhance the resized image.

The resize module 222 is thus able to send the smallest image possible without sacrificing image quality thereby allowing cost savings to both businesses and consumers. For example, a consumer being charged by the byte for data downloads will be charged less for receiving a smaller image due to the resizing. Similarly, a business that pays for sending data by the byte (e.g., charged by the byte by a cloud service) will be charged less for sending a smaller image due to the resizing.

FIG. 3 shows exemplary communications with a proxy involved, in accordance with embodiments of the present invention. FIG. 3 depicts an exemplary operating environment 300 and exemplary communications with a server 320 acting as a proxy between a client 202 and a server 210. The server 320 may described to operate in an “intercept mode” where it receives requests for a webpage or other Internet content and responds with webpages that are modified, as described herein, to allow resizing of images requested by the client 202. Embodiments of the present invention are thus configured to allow resizing of images in webpages and other Internet content without necessitating any changes to the webpages or content.

The server 320 includes an injection module 304 and resize module 204 that may be executed by the server 320. In some embodiments, the resize module 204 is part of a GPU. The server 210 includes a data store 312 which includes a webpage 314 and an image 316. The image 316 may be referenced by the webpage 314 and displayed as part of rendering the webpage 314. It is appreciated that webpage 314 may reference multiple images. Elements with similar numbers may operate in a substantially manner as described above.

In one exemplary embodiment, the server 320 is operated and/or controlled by a wireless service provider or other service provider with the purpose, among others, of reducing the bandwidth used on a communication network (e.g., a wireless network) operated by the service provider. This can allow cost savings for the service provider and allow the service provider to provide faster communications due to the reduction in bandwidth.

The browser module 204 sends a webpage request 250, as described above, to the server 320. The server 320 receives the webpage request 250 and in response sends a webpage request 354 to the server 210. The server 210 accesses the webpage 314 from the data store 312. It is noted that the webpage 314 does not include code for determining an image size of the image 316 when rendered as part of the webpage 314. The server 210 responds to the webpage request 354 by sending webpage 356.

The server 320 receives the webpage 356 and it is accessed by the injection module 304. The injection module 304 injects or adds programming instruction or “code” (e.g., code 218) to the webpage 356 and sends it to the browser module 204 of the client 202 as webpage 352. For example, the injection module 304 can add JavaScript code or a reference to JavaScript code (e.g., <script src=“size_determiner.js”></script>) configured for determining an image size of the image 316 when the webpage 352 is rendered. The browser module 204 then begins to process webpage 352 for rendering and launches the code that was added by the injection module 304. The code determines the size of each image of the webpage 352 (e.g., by querying or accessing layout information). The code then updates corresponding portions of the webpage 352 associated with the images (e.g., IMG tag URLs), as described herein.

The browser module 204 then sends image request 360 which is processed by the resize module 222. If there is not a copy of the image local to the server 320, the server 320 sends an image request 264 and receives the image from server 210 as described above. The resize module 222 resizes the image according to the size determined from the code executed by the browser module 204 and sends a resized image 262 to the browser module 204 for display. In some embodiments, the resized image 262 is stored or cached and sent by resize module 222 when the stored or cached image matches the size of the image requested by the client 202.

It is noted the server 320, which can be operated by a service provider, is providing the resized images. For example, the code could change the image source tags of the webpage 352 from IMG SRC=“http://website.com/.../image.jpg” to IMG SRC=“http://serviceprovider.com/.../image.jpg?width=200,height=300” thereby causing the image to requested from the server 320.

Embodiments of the present invention can thus resize images of currently existing websites without any need to modify the existing websites while allowing for reduced bandwidth utilization.

In some embodiments, the server 210 may be part of a cloud computing infrastructure without resizing capabilities and the resize module 222 is used to provide the resizing functionality while reducing the bandwidth utilization of the server 210 and thereby the cloud.

In some embodiments, the resize module 222 is used to generate one or more initial resized copies (e.g., four copies) of the image 316 to reduced access to the image 316 on the server 210 and allow of more rapid resizing as the closest size of the resized copies is used as a base image for generating resized images. This allows for increased speed and reduced storage utilization. For example, a photo sharing site may have a 20 megapixel image uploaded by a user and a 1080p copy the image is generated and used for resizing. Further, if many requests are received for a 720p sized copy of the image, a 720p version may be stored and used for resizing of future requests.

In some embodiments, a caching server may be between the client 202 and the server 320 with the caching server configured to cache resized images and send the resized image based on the image request 360. The caching server may send the image request 360 to the server 320 when the image size of the image request 360 is not present on the caching server.

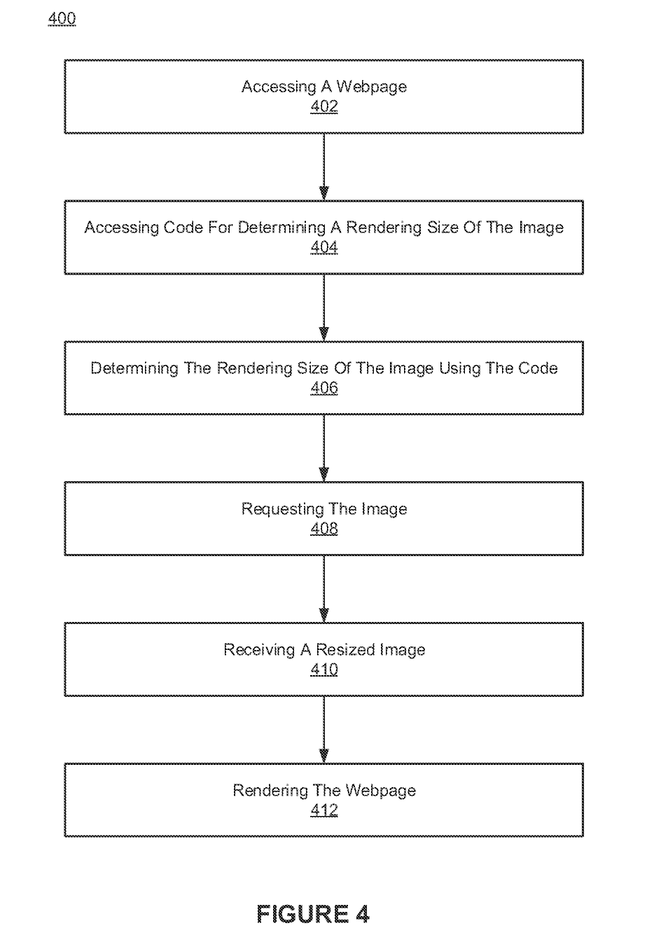

With reference to FIGS. 4-6, flowcharts 400-600 illustrate example functions used by various embodiments for facilitating resizing of images and/or resizing images, as described herein. Although specific function blocks (“blocks”) are disclosed in flowcharts 400-600, such steps are exemplary. That is, embodiments are well suited to performing various other blocks or variations of the blocks recited in flowcharts 400-600. It is appreciated that the blocks in flowcharts 400-600 can be performed in an order different than presented, and that not all of the blocks in flowcharts 400-600 need be performed.

FIG. 4 shows an exemplary computer implemented process for rendering a webpage, in accordance with various embodiments. FIG. 4 depicts a process 400 performed by a device (e.g., the client 202) executing a web browser. For example, the process 400 can be performed by a smartphone, tablet, or other mobile device executing a web browser.

At block 402, a webpage is accessed. The webpage can have an embedded image which is referenced in the webpage, as described herein.

At block 404, code for determining a rendering size of the image is accessed. The code may be accessed from the webpage or can be accessed based on a reference to the code in the webpage.

At block 406, the rendering size of the image is determined using the code. In some embodiments, the code queries a Document Object Model (DOM) of the webpage. In some embodiments, the code is configured to determine the rendering size of the image prior to the rendering of the webpage. Based on the determined size, the code is configured to modify the reference to the image of the webpage. The modified reference to the image of the webpage can include the rendering size of the image.

At block 408, the image is requested. The request for the image includes the rendering size of the image, as described herein.

At block 410, a resized image is received. The resized image has a size equal to the rendering size of the image, as described herein. In some embodiments, the resized image is generated by a Graphics Processing Unit (GPU). In some embodiments, the resized image is generated using just-in-time transcoding.

At block 412, the webpage is rendered and the resized image is displayed.

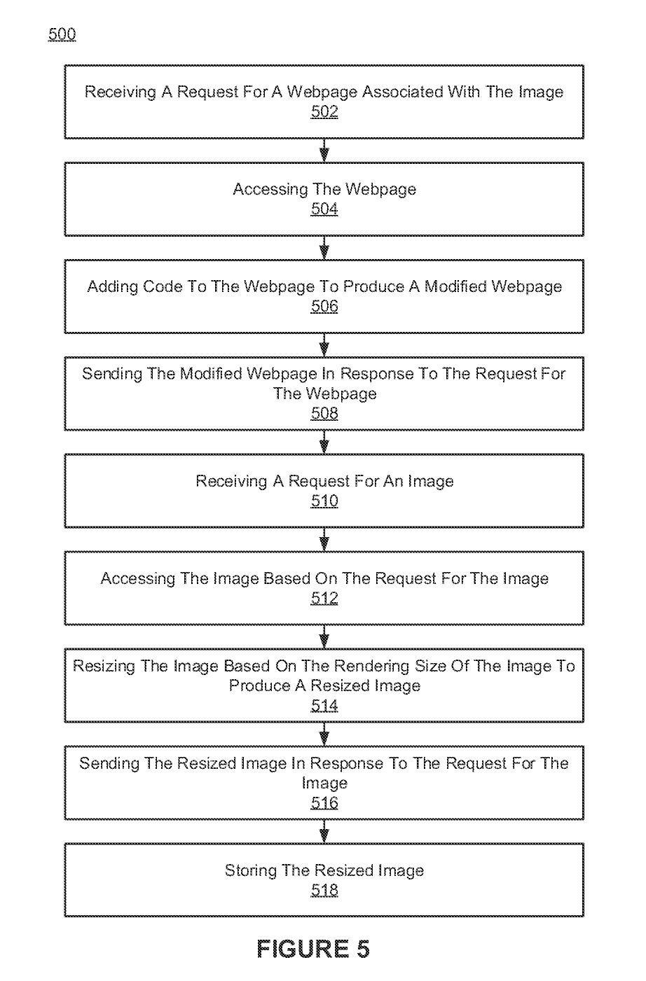

FIG. 5 shows an exemplary computer implemented process for processing a request, in accordance with various embodiments. FIG. 5 depicts a process 500 performed by a device (e.g., the server 220 or the server 320) configured to resize an image and/or inject, add, or insert code into a webpage (e.g., as described with respect to FIG. 3). For example, the process 500 can be performed by a server using a GPU, as described herein. In some embodiments, a first portion of process 500 may be performed by a CPU and a second portion performed by a GPU. Block 502-508 may be performed by a server injecting code for determining a rendering size of an image.

At block 502, a request for a webpage associated with an image is received, as described herein.

At block 504, the webpage is accessed. In some embodiments, the accessing of the webpage comprises accessing the webpage from local storage. In some embodiments, the accessing of the webpage comprises accessing the webpage from a remote source, as described herein.

At block 506, code is added to the webpage to produce a modified webpage. The code is configured for determining a rendering size of the image, as described herein.

At block 508, the modified webpage is sent in response to the request for the webpage.

At block 510, a request for an image is received. The request comprises a rendering size of the image, as described herein. In some embodiments, the request for the image comprises a Uniform Resource Location (URL) comprising the rendering size of the image.

At block 512, the image is accessed based on the request for the image. In some embodiments, the accessing of the image comprises accessing the image from local storage. In some embodiments, the accessing of the image comprises accessing the image from a remote source.

At block 514, the image is resized based on the rendering size of the image to produce a resized image, as described herein. In some embodiments, the resizing of the image based on the rendering size of the image is performed with a Graphics Processing Unit (GPU). In some embodiments, the resizing of the image is performed based on a quality factor. In some embodiments, the resized image is produced with just-in-time transcoding.

At block 516, the resized image is sent in response to the request for the image.

At block 518, the resized image is stored. The resized image may be stored as part of a caching operation to provide the resized image in response to future requests without necessitating resizing of the image.

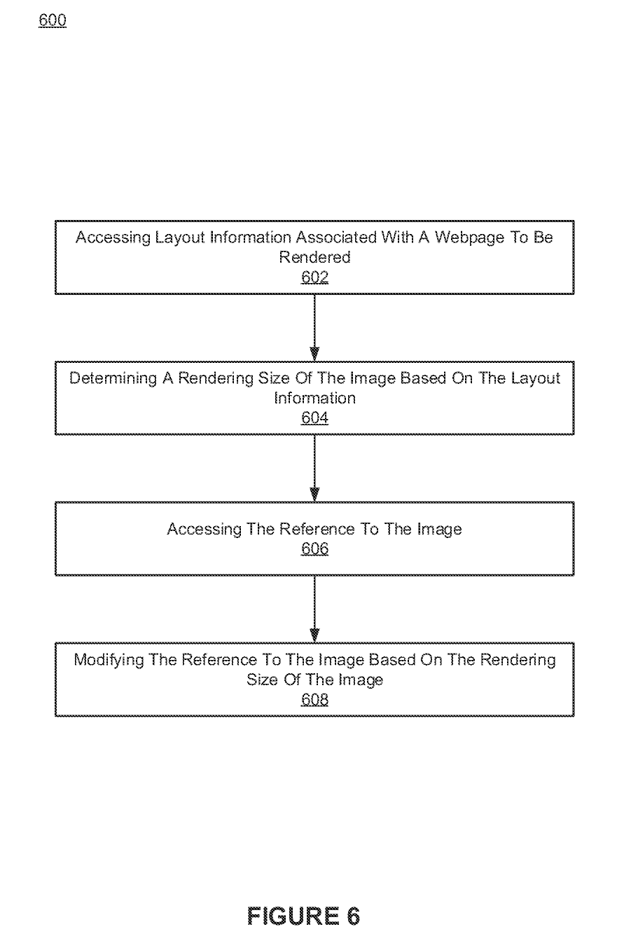

FIG. 6 shows an exemplary computer implemented process for facilitating resizing of an image, in accordance with various embodiments. FIG. 6 depicts a process 600 performed by a device (e.g., the client 202) executing a web browser. For example, the process 600 can be performed by a smartphone, tablet, or other mobile device.

At block 602, layout information associated with a webpage to be rendered is accessed. The webpage comprises a reference to the image. In some embodiments, the reference to the image comprises a Uniform Resource Locator (URL). In some embodiments, the accessing of the layout information comprises querying a Document Object Model (DOM).

At block 604, a rendering size of the image is determined based on the layout information, as described herein.

At block 606, the reference to the image is accessed. In one embodiment, the reference to the image is a URL.

At block 608, the reference to the image is modified based on the rendering size of the image, as described herein. In some embodiments, the modifying of the reference to the image comprises modifying the reference to include the rendering size of the image.

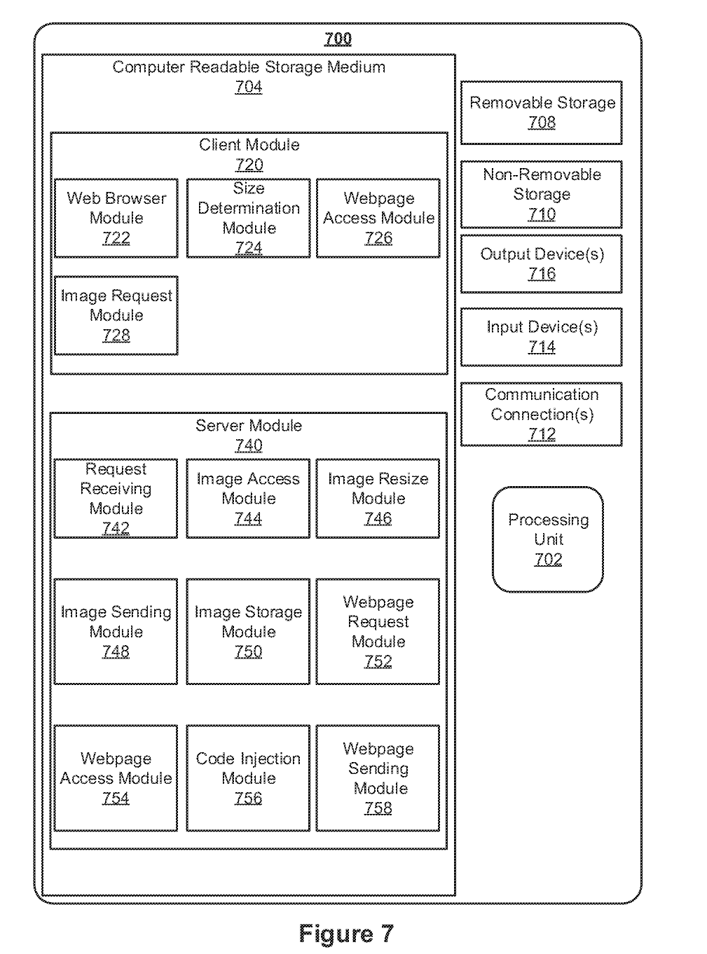

Referring now to FIG. 7, a block diagram of a computer system platform and associated modules in accordance with various embodiments is shown. With reference to FIG. 7, example system modules for implementing embodiments disclosed above, such as those described in FIGS. 1-6. The system includes a general purpose computing system environment, such as computing system environment 700. The computing system environment 700 may include servers, desktop computers, laptops, tablets, mobile devices, and smartphones, etc. The computing system environment 700 typically includes at least one processing unit 702 and computer readable storage medium 704. Depending on the exact configuration and type of computing system environment, computer readable storage medium 704 is volatile (such as RAM), non-volatile (such as ROM, flash memory, etc.) or some combination of the two. Portions of computer readable storage medium 704 when executed may perform methods of determining a rendering size of an image and processing image requests, as described herein.

Additionally in various embodiments, the computing system environment 700 may also have other features/functionalities. For example, the computing system environment 700 may also include additional storage (removable and/or non-removable) including, but not limited to, magnetic or optical disks or tape. Such additional storage is illustrated by removable storage 708 and non-removable storage 710. Computer storage media includes volatile and nonvolatile, removable and non-removable media implemented in any method or technology for storage of information such as computer readable instructions, data structures, program modules or other data. Computer readable medium 704, removable storage 708 and nonremovable storage 710 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by the computing system environment 700. Any such computer storage media is part of the computing system environment 700.

The computing system environment 700 may also contain communications connection(s) 712 that allow it to communicate with other devices. Communications connection(s) 712 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 712 may allow the computing system environment 700 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that the communication connection(s) 712 connect to may run a plurality of network protocols including transmission control protocol (TCP), user datagram protocol (UDP), Internet Protocol (IP), real-time transport protocol (RTP), real-time transport control protocol (RTCP), file transfer protocol (FTP), and hypertext transfer protocol (HTTP), etc.

In further embodiments, the computing system environment 700 may also have input device(s) 714 such as a keyboard, mouse, a terminal or terminal emulator (either directly connected or remotely accessible via telnet, SSH, HTTP, SSL, etc.), a pen, voice input device, touch input device, a remote control, etc. Output device(s) 2016 such as a display, speakers, LEDs, etc., may also be included.

The computer readable storage medium 704 includes a client module 720 and a server module 740. It is appreciated that one or more portions of the client module 720 and the server module 740 may reside on one or more devices and may be transferred between devices. For example, the size determination module 724 may be code (e.g., JavaScript) that is downloaded by a client device (e.g., the client device 220) from a server (e.g., the server 220 or the server 320).

The client module 720 includes a web browser module 722, a size determination module 724, a webpage access module 726, and an image request module 728. The web browser module 722 is configured for receiving user requests for a webpage, requesting the webpage and associated resources (e.g., images), and executing code associated with the webpage, and rendering the webpage. The webpage access module 726 is configured for accessing a webpage, as described herein. The image request module 728 is configured to request an image associated with a webpage. In some embodiments, the webpage access module 726, the image request module 728, and/or the size determination module 724 may be part of the web browser module 722.

The size determination module 724 is configured for accessing layout information associated with a webpage to be rendered and determining a rendering size of the image based on the layout information, as described herein. The size determination module may be further configured to access a reference to the image and modify the reference to the image based on the rendering size of the image, as described herein.

The server module 740 includes a request receiving module 742, an image access module 744, an image resize module 746, an image sending module 748, an image storage module 750, a webpage request module 752, a webpage access module 754, a code injection module 756, and a webpage sending module 758.

The request receiving module 742 is configured for receiving a request for an image, as described herein. The image access module 744 is configured for accessing an image, which may be local or remote, as described herein. The image resize module 746 is configured to resize an image (e.g., part of a GPU or executed by a GPU), as described herein. The image sending module 748 is configured for sending a resized image, as described herein. The image storage module 750 is configured to store a resized image (e.g., for caching purposes), as described herein. The webpage request module 752 is configured to request a page webpage. The webpage access module 754 is configured to access a received webpage, as described herein. The code injection module 756 is configured to inject, add or insert code for determining a rendering size of one or more images of a webpage, as described herein. The webpage sending module 758 is configured for sending a modified webpage (e.g., to a client), as described herein.

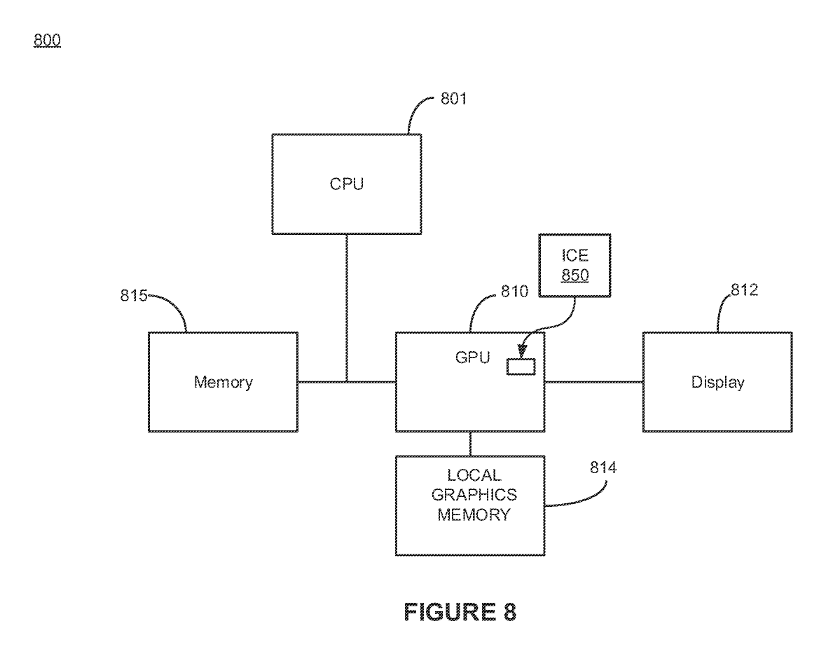

FIG. 8 shows exemplary computer system 800 in accordance with one embodiment of the present invention. Computer system 800 depicts the components of a generic computer system in accordance with embodiments of the present invention providing the execution platform for certain hardware-based and software-based functionality. In general, computer system 800 comprises at least one CPU 801, a system memory 815, and at least one graphics processor unit (GPU) 810. The CPU 801 can be coupled to the system memory 815 via a bridge component/memory controller (not shown) or can be directly coupled to the system memory 815 via a memory controller (not shown) internal to the CPU 801. The GPU 810 may be coupled to a display 812. One or more additional GPUs can optionally be coupled to system 800 to further increase its computational power. The GPU(s) 810 is coupled to the CPU 801 and the system memory 815. The GPU 810 can be implemented as a discrete component, a discrete graphics card designed to couple to the computer system 800 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 814 can be included for the GPU 810 for high bandwidth graphics data storage. In some embodiments, the GPU 810 includes an image compute engine (ICE) 850 which is configured to dynamically and rapidly resize images, as described herein.

The CPU 801 and the GPU 810 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 810 can also be implemented in, and performed by, a suitably equipped CPU 801. Additionally, while embodiments herein may make reference to a GPU, it should be noted that the described circuits and/or functionality can also be implemented and other types of processors (e.g., general purpose or other special-purpose coprocessors) or within a CPU.

In one exemplary embodiment, GPU 810 is operable for General-purpose computing on graphics processing units (GPGPU) computing. GPU 810 may execute Compute Unified Device Architecture (CUDA) programs and Open Computing Language (OpenCL) programs. GPU 810 may thus be used for a variety of computing applications including simulations of molecular dynamics, computational fluid dynamics, reservoir simulations, and finite structural problems. It is appreciated that the parallel architecture of GPU 810 may have significant performance advantages over CPU 801.

System 800 can be implemented as, for example, a desktop computer system or server computer system having a powerful general-purpose CPU 801 coupled to a dedicated graphics rendering GPU 810. In such an embodiment, components can be included that add peripheral buses, specialized audio/video components, IO devices, and the like. Similarly, system 800 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 800 can also be implemented as a “system on a chip” (SoC), where the electronics (e.g., the components 801, 815, 810, 814, and the like) of a computing device are wholly contained within a single integrated circuit die. Examples include a hand-held instrument with a display, a car navigation system, a portable entertainment system, and the like.

In the foregoing specification, embodiments have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method of rendering a webpage, the method comprising:
accessing the webpage, wherein the webpage comprises an image;
accessing code for determining a rendering size of the image;
determining the rendering size of the image using the code;
requesting the image wherein the request comprises the rendering size of the image;
receiving a resized image, wherein the resized image has a size equal to the rendering size of the image;
rendering the webpage, wherein the rendering of the webpage comprises displaying the resized image.

2. The method of claim 1 further comprising generating the resized image by a Graphics Processing Unit (GPU).

3. The method of claim 1, wherein the code queries a Document Object Model (DOM) of the webpage.

4. The method of claim 1, wherein the code is configured to determine the rendering size of the image prior to the rendering of the webpage.

5. The method of claim 1, wherein the code is configured to modify a reference to the image of the webpage.

6. The method of claim 5, wherein the reference to the image of the webpage comprises the rendering size of the image.

7. The method of claim 1 further comprising generating the resized image using just-in-time transcoding.

8. A method of processing a request, the method comprising:
receiving a request for an image, wherein the request comprises a rendering size of the image;
accessing the image based on the request for the image;
resizing the image based on the rendering size of the image to produce a resized image; and
sending the resized image in response to the request for the image.

9. The method of claim 8, wherein the accessing of the image comprises accessing the image from local storage.

10. The method of claim 8, wherein the accessing of the image comprises accessing the image from a remote source.

11. The method of claim 8 further comprising:
storing the resized image.

12. The method of claim 8 further comprising:
receiving a request for a webpage associated with the image;
accessing the webpage;
adding code to the webpage to produce a modified webpage, wherein the code is configured for determining a rendering size of the image; and
sending the modified webpage in response to the request for the webpage.

13. The method of claim 8, wherein the resizing of the image based on the rendering size of the image is performed with a Graphics Processing Unit (GPU).

14. The method of claim 13, wherein the resized image is produced with just-in-time transcoding.

15. The method of claim 8, wherein the request for the image comprises a Uniform Resource Location (URL) comprising the rendering size of the image.

16. The method of claim 8, wherein the resizing of the image is performed based on a quality factor.

17. A computer-readable storage medium having stored thereon, computer executable instructions that, if executed by a computer system cause the computer system to perform a method for facilitating resizing of an image, the method comprising:
accessing layout information associated with a webpage to be rendered, wherein the webpage comprises a reference to the image;
determining a rendering size of the image based on the layout information;
accessing the reference to the image; and
modifying the reference to the image based on the rendering size of the image.

18. The computer-readable storage medium of claim 17, wherein the accessing of the layout information comprises querying a Document Object Model (DOM).

19. The computer-readable storage medium of claim 17, wherein the rendering size of the image is based on the resolution of a display device.

20. The computer-readable storage medium of claim 17, wherein the modifying of the reference to the image comprises modifying the reference to include the rendering size of the image.
